(19) United States
(12) Patent Application Publication
(10) Pub. No.: US 2002/0141644 A1
(43) Pub. Date: Oct. 3, 2002

(54) System for conducting fortune telling and character analysis over internet based on names of any language

(76) Inventor: Tawei Lin, Taipei (TW)

Correspondence Address: RABIN & CHAMPAGNE, P.C., Suite 500, 1101 14th Street, N.W., Washington, DC, 20005, US

(21) Appl. No.: 09/819,723

(22) Filed: Mar. 29, 2001

(51) Int. Cl. G06K 9/00

(52) U.S. Cl. 382/181; 382/229

(57) ABSTRACT

A system for conducting fortune telling and character analysis over Internet based on an entered name of any language is provided. The system includes a host, a database, one or more terminals, and a communicating system connecting the host, the database and the terminal to one another. The database is capable of analyzing implied meanings of names of any language entered at the terminal in accordance with traditional Chinese fortune telling theories and thereby providing judgments on good or bad signs possibly represented by the entered names. The implied meanings of names are obtained either from numbers of strokes of the entered names or from meanings or origins of words constituting the entered names.

### FIELD OF THE INVENTION

The present invention relates to a system for conducting fortune telling and character analysis over Internet based on implied meanings of names of any language.

### BACKGROUND OF THE INVENTION

Fortune telling and character analysis is an ancient and profound knowledge developed in the Chinese culture to predict a person's future. There are various ways of deduction and different elements used in the Chinese fortune telling and character analysis, including the four-pillar theory, the “Chi-Wei-Dou-Su”, the horoscopes, the astrology, etc. Up to date, all these deduction ways and elements for fortune telling and character analysis are based on names in Chinese, either traditional or simplified Chinese, and/or the date of a person's birth indicated by the lunar calendar, and they are not applicable to names in non-Chinese language.

However, there are many occasions for a person to use a name in non-Chinese language, particular in English, rather than the name in Chinese, such as in applying for a credit card, passport, etc. For most Chinese, their non-Chinese name may be a transliteration of the Chinese name or a common name in any foreign language. In either case, none of the currently available ways for fortune telling and character analysis could satisfy a person who wishes to know whether his or her non-Chinese name represents any good or bad sign.

Due to the mystic nature of the fortune telling and character analysis, it has been suggested as a means to promote business over Internet. That is, commercial organizations may include the fortune telling and character analysis in their web sites to attract more people to browse their web site and therefore create more chances of successful commercial transactions over Internet. For this purpose, it is desirable to develop a system that enables fortune telling and character analysis to be conducted over Internet based on not only Chinese names but also non-Chinese names.

### SUMMARY OF THE INVENTION

It is therefore a primary object of the present invention to provide a system for conducting fortune telling and character analysis over Internet based on implied meanings of names of any language, and providing judgments on good or bad signs possibly represented by such names.

The system of the present invention mainly includes a host, a database, one or more terminals, and a communicating system connecting the host, the database and the terminals to one another. When a user enters a name in any language, including a surname and a given name, at a terminal via an interface provided by the host, the database is capable of comparing the entered name with data stored in the database and locating any data that match with or correspond to the entered name, and then analyzing the implied meanings of the entered name to provide judgments on good or bad signs possibly represented by the entered names.

The database is able to analyze the implied meanings of a name in any language either based on numbers of strokes of the entered surname and given name or based on meanings or origins of words constituting the entered surname and given name.

The system of the present invention allows users to enter names in any language and is able to conduct a quick fortune and character analysis based on the entered name. By including the system of the present invention in a web site through Internet, it is possible to attract more people to browse the web site.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic view showing the system according to the present invention for conducting fortune telling and character analysis over Internet based on a name in any languages;

FIG. 2 is a flowchart showing the operation of the system of the present invention of FIG. 1;

FIG. 3 is a schematic view showing the system according to the present invention for conducting fortune telling and character analysis over Internet based on number of strokes of a name in any languages;

FIG. 4 is a flowchart showing the operation of the system of FIG. 3;

FIG. 5A explains the relation between the number of strokes of a name and the fortune of a person having the name as defined in the traditional Chinese fortune telling theory;

FIG. 5B is a table explaining the relation between the number of strokes of a name and the fortune of a person having the name as defined in the system of the present invention;

FIG. 6 shows data stored in a database in the system of the present invention shown in FIG. 3;

FIG. 7A shows a first example of analyzing a name in English with the system of the present invention;

FIG. 7B shows a second example of analyzing a name in English with the system of the present invention;

FIG. 7C shows a third example of analyzing a name in English with the system of the present invention; and

FIG. 8 shows examples of data stored in a database in a system of the present invention for character analysis based on meaning of word constituting a name in English.

### DETAILED DESCRIPTION OF THE PREFERRED EMBODIMENTS

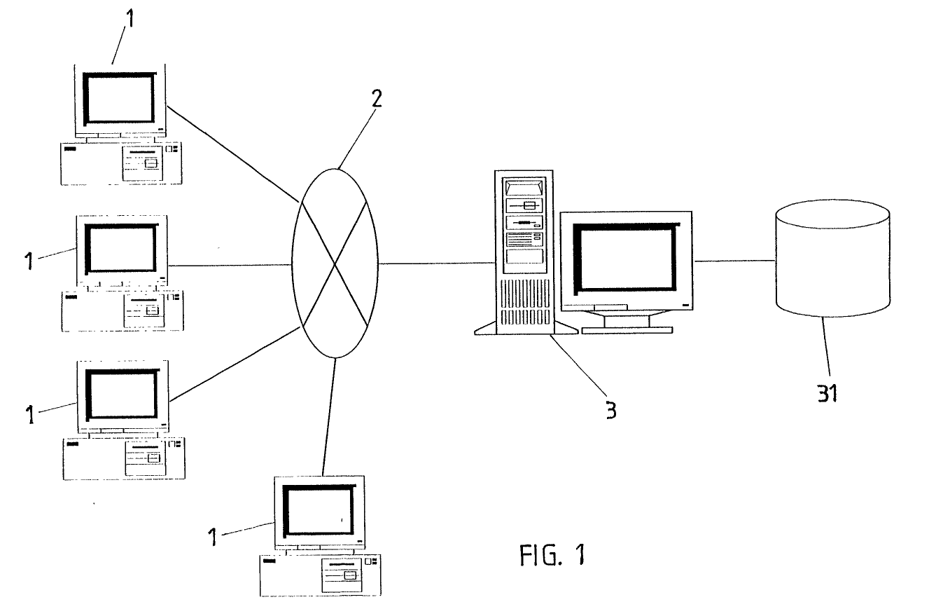

Please refer to FIG. 1 that shows a system according to the present invention for conducting fortune telling and character analysis over Internet based on a name in any languages. The system mainly includes a plurality of terminals 1, a host 3, and a database 31 connected to one another via a communicating system 2. In the database 31, data for fortune telling and character analysis based on implied meanings of a name in any language are stored. The communicating system 2 employed in the present invention is Internet.

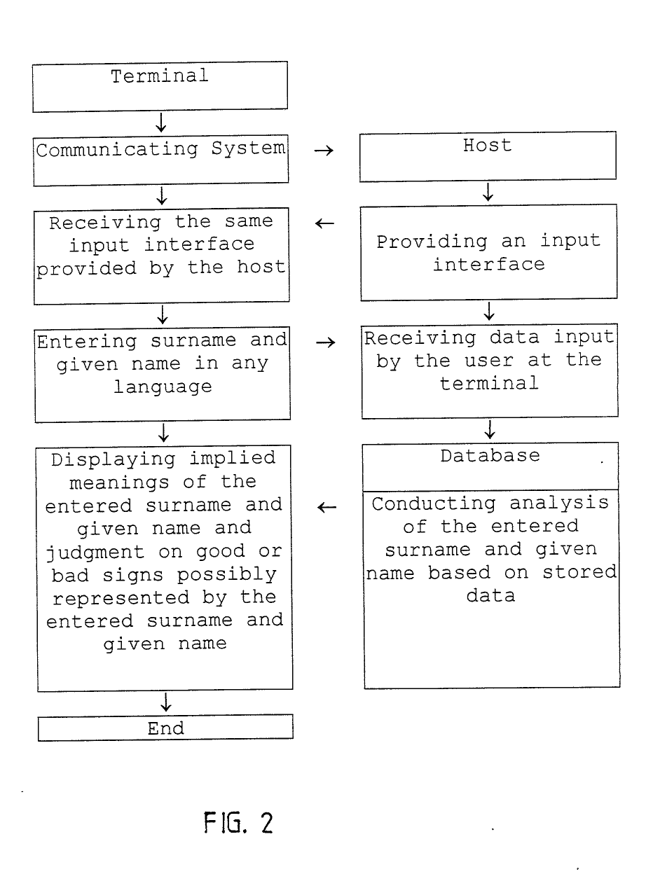

Please refer to FIG. 2 that is a flowchart showing the operation of the system of the present invention shown in FIG. 1. An end user at a terminal 1 is connected to the host 3 via the communicating system 2, which is Internet in the present invention. The host 3 provides an input interface that is transmitted to the terminal 1, so that the terminal 1 receives the same input interface transmitted by the host 3. When the end user enters at the terminal 1 a name, including a surname and a given name in any foreign language, the entered name is transmitted to the host 3. When the host 3 receives the entered name from the terminal 1, the database 31 analyzes implied meanings of the entered surname and given name based on data stored therein and provides a judgment on any good or bad sign possibly represented by the entered name. The judgment is then transmitted from the host 3 to the terminal 1 for displaying on a monitor of the terminal 1.

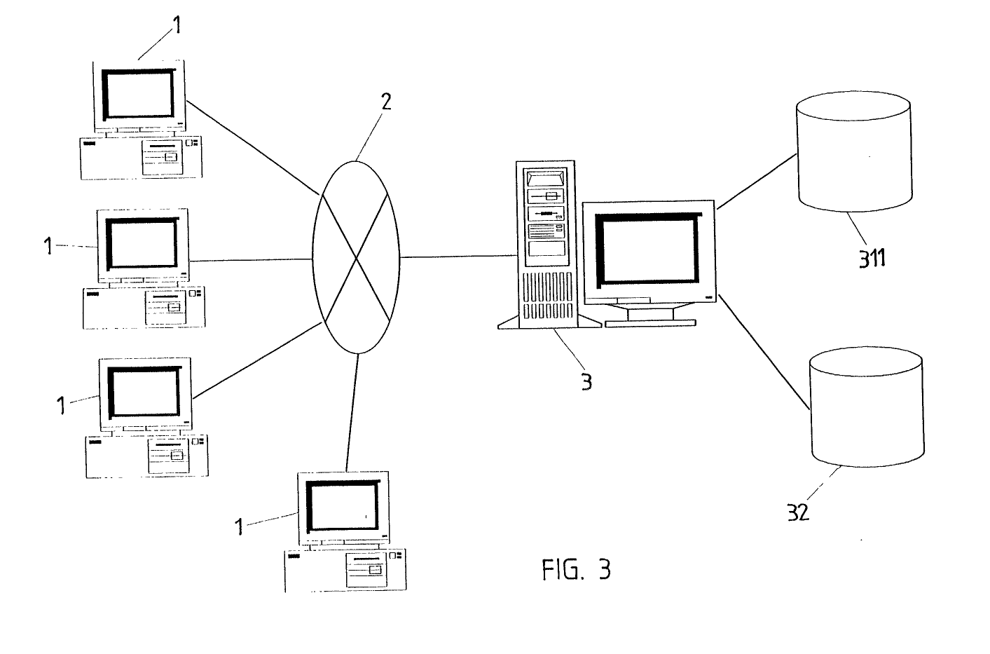

The database 31 is able to analyze the implied meanings of an entered name in any language either based on numbers of strokes of the entered surname and given name or based on meanings or origins of words constituting the entered surname and given name. Please refer to FIG. 3 that shows a system of the present invention for conducting fortune telling and character analysis over Internet based on number of strokes of an entered name. In this system, there are one more terminals 1 and a host 3 connected to one another via a communicating system 2, which is Internet in the present invention, and a database 311 and an operating unit 32 connected to the host 3. The database 311 is able to compare an entered name, including a surname and a given name in any language, with data stored in the database 311 to locate numbers of strokes of all letters included in the entered names as well as numbers of strokes of the entered surname and given name. The operating unit 32 sums up numbers of strokes of the entered surname and given name provided by the database 311 in predetermined manners to provide analyses of fortune and any good or bad sign possibly represented by the entered name.

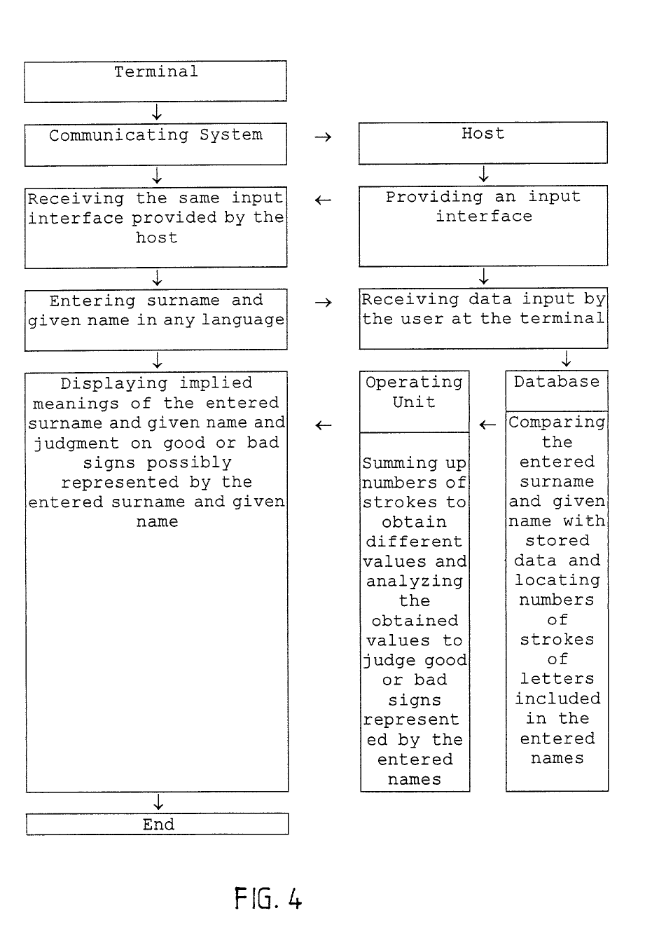

FIG. 4 is a flowchart showing the operation of the system of FIG. 3. An end user at a terminal 1 is connected to the host 3 via the communicating system 2, which is Internet in the present invention. The host 3 provides an input interface that is transmitted to the terminal 1, so that the terminal 1 receives the same input interface transmitted by the host 3. When the end user enters a name at the terminal 1, including a surname and a given name in any foreign language, the entered name is transmitted to the host 3. When the host 3 receives the entered name from the terminal 1, the database 311 of the host 3 compares the entered name with data stored therein and locates numbers of strokes of all letters included in the entered name, as well as numbers of strokes of the entered surname and the given name. Data of numbers of strokes of the entered surname and given name located by the database 311 are sent to the operating unit 32, at where the obtained numbers of strokes of entered names are summed up in predetermined manner for the purpose of analyzing the fortune and the character of a person having the entered name. A result from the analysis and a judgment on any good or bad sign possibly represented by the entered name are then sent to the terminal 1 for displaying on a monitor thereof.

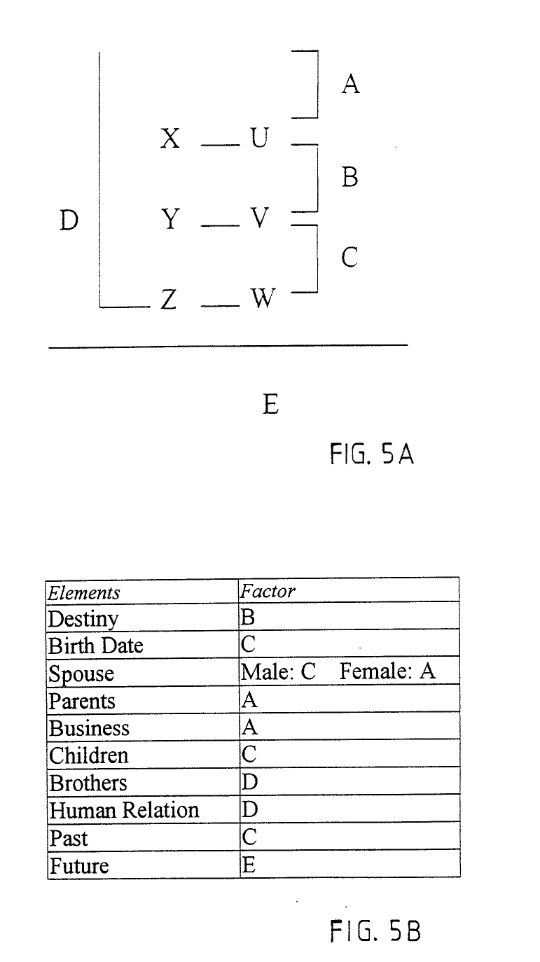

Please refer to FIG. 5A that shows a relation between the number of strokes of a name and the fortune of a person having the name as defined in the traditional Chinese fortune telling theory. A Chinese generally has a name consisting of three Chinese characters that are denoted as X, Y and Z hereinafter. Among these three characters, the first one is a surname and the other two together forms a given name. The Chinese characters X, Y and Z respectively include several strokes, and numbers of strokes of these characters are denoted as U, V and W. The numbers of strokes U, V and W of the character or word constituting the surname and the given name X, Y and Z are summed according to the following formulas (1) to (5), so that results from the operations correspond to five factors that are important bases in analyzing the fortune and character of a person having the entered name. These five factors are Heaven, Human, Earth, External Environment, and Universe, which are sequentially denoted as A, B, C, D and E. The formulas (1) to (5) are as follows:

A(Heaven)=U+1 (1)

B(Human)=U+V (2)

C(Earth)=V+W (3)

D(External)=W+1 (4)

E(Universe)=U+V+W (5)

where U is the number of strokes of the first character X (i.e. the surname), V is the number of strokes of the second character Y (i.e. the first given name), and W is the number of strokes of the third character Z (i.e. the second given name).

Exact values for A, B, C, D and E are referred to as divine values of Heaven, Human, Earth, External Environment, and Universe, and could be easily obtained through operations on a computer. Some Chinese people have a surname that includes two Chinese characters or a given name that includes only one Chinese character. In either case, the divine values of Heaven, Human, Earth, External Environment, and Universe must still be calculated in accordance with principles stipulated in the traditional Chinese fortune telling and character analysis, that is, the formulas (1) to (5). Although the five factors A, B, C, D and E have their respective meaning in terms of the traditional Chinese fortune telling and character analysis, they are not easily understood. To overcome this problem, the five factors A, B, C, D and E are sub-divided into ten major elements in the system of present invention to correspond to issues that are most concerned by all people. Please refer to FIG. 5B. The ten major elements are Destiny, Birth Date, Spouse, Parents, Business, Children, Brothers, Human Relation, Past, and Future.

The present invention is characterized in that it allows a user over Internet to enter his or her surname and given name in any language at a terminal. Then, numbers of strokes of letters constituting the entered surname and given name are compared with data stored in the database. There are many different foreign languages available for entering the user's surname and given name. However, the following embodiments of the present invention are based on entered names in English.

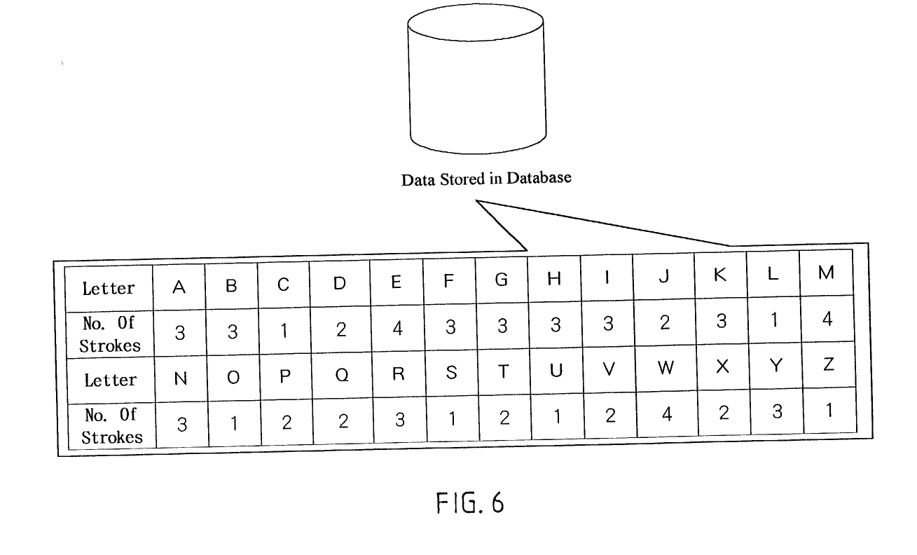

For the purpose of analyzing a user's name in English, data about numbers of strokes for 26 English letters from A to Z in upper case are stored in the database 311 provided by the host 3 of the present invention, as shown in FIG. 6. For example, uppercase letter A is defined as having three strokes, uppercase letter B three strokes, uppercase letter C one stroke, uppercase letter D two strokes, and uppercase letter Z one stroke.

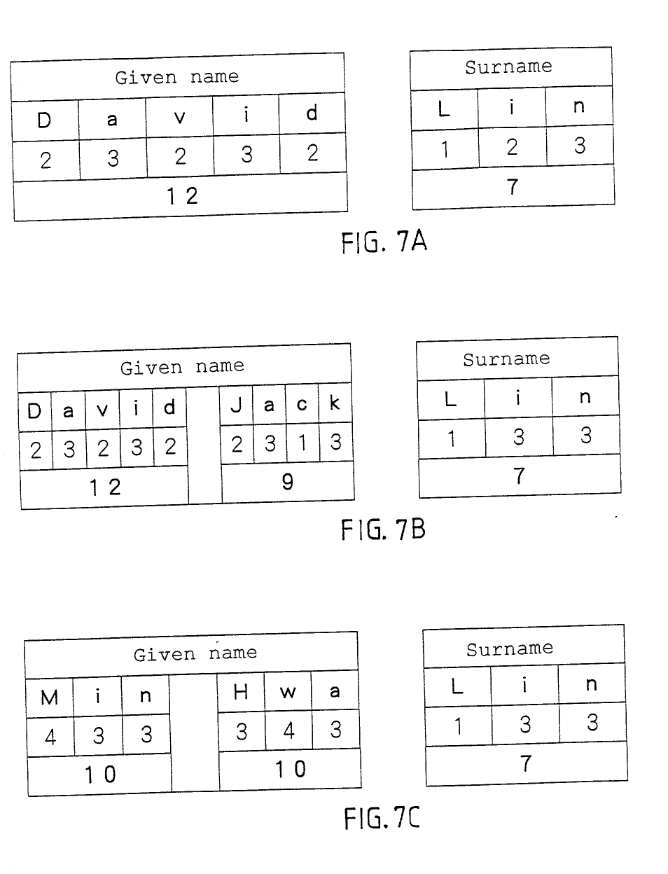

Please refer to FIGS. 6 and 7A at the same time. When a user enters an English name as David Lin, that includes a surname “Lin” having only one word and a given name “David” also having only one word, the database 311 starts comparing the entered name with data stored therein and searches for matched data. In doing so, all English letters included in the surname and the given name are separated and converted into upper case to obtain the numbers of strokes of these letters. More specifically, letters D, A, V, I, and D included in the given name “David” respectively have 2, 3, 2, 3, and 2 strokes; and letters L, I, and N included in the surname “Lin” respectively have 1, 3 and 3 strokes. Thereafter, the operating unit 32 sums up the numbers of strokes of all English letters included in the given name and in the surname to obtain total strokes of 12 and 7 for the user's given name and surname, respectively.

Please refer to FIGS. 5A. In this figure, X corresponds to the surname “Lin”, Y to the single-word given name “David”, and Z corresponds to nothing. U is the number of strokes of the surname X and is 7 in the embodiment of FIG. 7A, V is the number of strokes of the given name “David” and is 12 in the same embodiment, and W is defined as 1. From the above-mentioned formulas (1) to (5), it can be easily derived that the user's Heaven factor A=U+1=7+1=8; the Human factor B=U+V=7+12=19; the Earth factor C=V+W=12+1=13; the External Environment factor D=W+1=1+1=2; and the Universe factor E=U+V+W=7+12+1=20. As can be seen in FIG. 5B, the ten major elements defined in the present invention separately correspond to one of the five factors A to E. After the exact values for the user's five factors are obtained through the above operation, the user's fortune and character are analyzed and judgment on any good or bad sign represented by these values is made based on the values of the five factors corresponding to the ten major elements.

Please refer to FIG. 7B. When a user enters an English name as David Jack Lin, that includes a surname “Lin” having only one word and a given name “David Jack” having two words, the database 311 starts comparing the entered name with data stored therein and searches for matched data. In doing so, all English letters included in the surname and the given name are separated and converted into upper case to obtain the numbers of strokes of these letters. More specifically, the surname “Lin” has a total number of strokes of 7 and the two words of “David” and “Jack” of the given name have total numbers of strokes of 12 and 9, respectively. Thereafter, the operating unit 32 conducts operation to obtain the values of the user's five factors as 8 for the Heaven factor A, 19 for the Human factor B, 21 for the Earth factor C, 10 for the External Environment factor D, and 28 for the Universe factor E. After the values of the user's five factors are obtained through the above operation, the user's fortune and character are analyzed and judgment on any good or bad sign represented by these values is made based on the values of the five factors corresponding to the ten major elements.

Please refer to FIG. 7C. When a user enters an English name as Lin Min Hwa, that includes a surname “Lin” having only one word and a given name “Min Hwa” having two words, the database 311 starts comparing the entered name with data stored therein and searches for matched data. In doing so, all English letters included in the surname and the given name are separated and converted into upper case to obtain the numbers of strokes of these letters. More specifically, the surname “Lin” has a total number of strokes of 7 and both of the two words of “Min” and “Hwa” of the given name have a total number of strokes of 10. Thereafter, the operating unit 32 conducts operation to obtain the values of the user's five factors as 8 for the Heaven factor A, 17 for the Human factor B, 20 for the Earth factor C, 11 for the External Environment factor D, and 27 for the Universe factor E. After the values of the user's five factors are obtained through the above operation, the user's fortune and character are analyzed and judgment on any good or bad sign represented by these values is made based on the values of the five factors corresponding to the ten major elements.

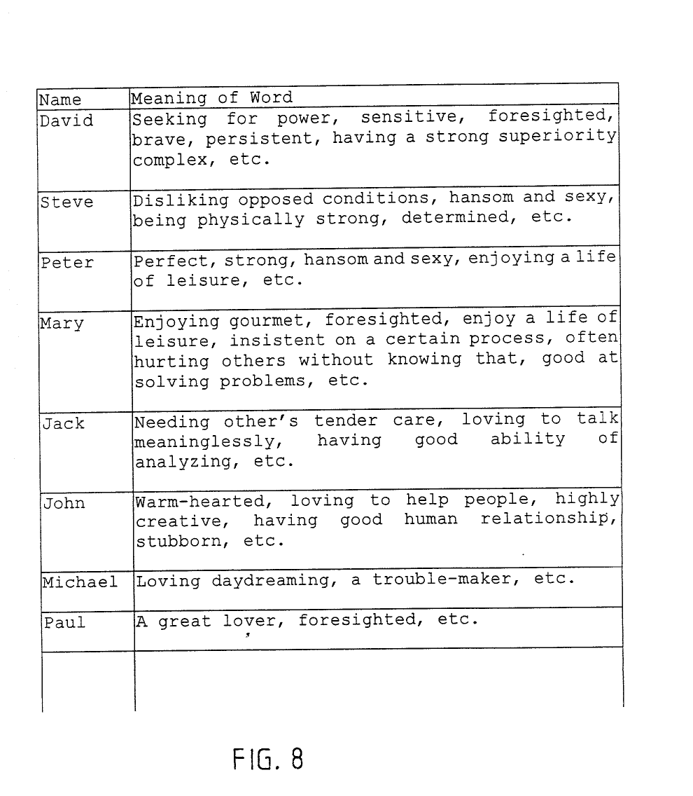

Alternatively, the host 3 of the present invention may conduct fortune telling and character analysis for a user based on meanings and origin of words constituting an entered name in any language, which is English in the illustrated example of FIG. 8. In this case, data stored in a database of the host 3 are implied meanings and origins of words when the same are used as names. For example, the word “David” as a name has an original meaning of seeking for power, sensitive, foresighted, brave, persistent, having a strong superiority complex, etc. Thus, from an analysis conducted by the system of the present invention, a person having the entered name of “David” would be judged as having the attribute of a leader. And, as another example, the word “Steve” as a name has an original meaning of disliking opposed conditions, hansom and sexy, being physically strong, determined, etc. Thus, from an analysis conducted by the system of the present invention, a person having the entered name of “Steve” would be judged as loving peace and rational.

In brief, the present invention is able to conduct fortune telling and character analysis based a name in any language entered by the user at an Internet-connected terminal. The analysis is made either based on values of specially factors concerning a person fortune obtained from numbers of strokes of the entered names or based on implied meanings or origins of words constituting the entered names. The system of the present invention allows users to enter names in any language and is able to conduct a quick fortune and character analysis based on the entered name. By including the system of the present invention in a web site through Internet, it is possible to attract more people to browse the web site.

The present invention has been described with some embodiments thereof and it is understood that many changes and modifications in the described embodiments can be carried out without departing from the scope and the spirit of the invention that is intended to be limited only by the appended claims.

What is claimed is:

1. A system for conducting fortune telling and character analysis over Internet based on names in any language, comprising a host, a database connected to said host, one or more terminals, and a communicating system for connecting said one or more terminals to said host;
said host including interfaces that can be provided to said one or more terminals for users at said terminals to enter surnames and given names in a selected language via said interfaces;
said database storing data concerning implied meanings of different surnames and given names in any languages as defined in accordance with traditional fortune telling theories, and being capable of comparing an entered name with said stored data to locate any of said data corresponding to said entered name for use as an basis for conducting said fortune telling and character analysis; and
said one or more terminals being connected to said host via said communicating system and being capable of receiving interfaces the same as that provided by said host for a user to enter a surname and a given name at any of said terminals;
whereby when a user enters a surname and a given name in any language at one of said terminals via said interface provided by said host to said terminal, said host receives said entered surname and given name, and said database compares said entered surname and given name with said data stored in said database to locate any data showing implied meanings of said entered surname and given name defined by traditional Chinese fortune telling theories, and provides a judgment on good or bad sign possibly represented by said entered surname and given name by analyzing said implied meanings thereof.

2. A system for conducting fortune telling and character analysis over Internet based on names in any language, comprising a host, a database connected to said host, an operating unit, one or more terminals, and a communicating system for connecting said one or more terminals to said host;
said host including interfaces that can be provided to said one or more terminals for users at said terminals to enter surnames and given names in a selected language via said interfaces;
said database storing data concerning numbers of strokes of all letters of different languages, and being capable of comparing entered surname and given name with said stored data to provide numbers of strokes of all letters of said entered names and total numbers of strokes of said entered names for use as an basis for conducting said fortune telling and character analysis;
said operating unit summing up said total numbers of strokes of said entered surname and given name according to predetermined formulas defined by traditional Chinese fortune telling theories to obtain different values, and providing a judgment on good or bad sign possibly represented by said entered surname and given name by analyzing said obtained values; and
said one or more terminals being connected to said host via said communicating system and being capable of receiving interfaces the same as that provided by said host for a user to enter a surname and a given name at any of said terminals;
whereby when a user enters a surname and a given name in any language at one of said terminals via said interface provided by said host to said terminal, said host receives said entered surname and given name, and said database compares said entered surname and given name with said data stored in said database to locate any data showing numbers of strokes of said entered surname and given name defined by a predetermined manner, and said operating unit sums up said numbers of strokes of said entered names according to predetermined formulas to obtain different values and provides a judgment on good or bad sign possibly represented by said entered surname and given name by analyzing said obtained values.

3. A system for conducting fortune telling and character analysis over Internet based on names in any language, comprising a host, a database connected to said host, one or more terminals, and a communicating system for connecting said one or more terminals to said host;
said host including interfaces that can be provided to said one or more terminals for users at said terminals to enter surnames and given names in a selected language via said interfaces;
said database storing data of implied meanings and origins of words constituting surnames and given names in any languages and being capable of comparing an entered name with said stored data to provide a judgment on the character of a person having said entered name; and
said one or more terminals being connected to said host via said communicating system and being capable of receiving interfaces the same as that provided by said host for a user to enter a surname and a given name at any of said terminals;
whereby when a user enters a surname and a given name in any language at one of said terminals via said interface provided by said host to said terminal, said host receives said entered surname and given name, and said database compares said entered surname and given name with said data stored in said database to locate any of said stored data showing implied meanings and origins of words constituting said entered names, and uses said located data to provide a judgment on fortune and character of a person having said entered name.
